(19) United States
(12) Patent Application Publication
(10) Pub. No.: US 2024/0089089 A1
(43) Pub. Date: Mar. 14, 2024

(54) USING DECENTRALIZED NETWORKS TO ENSURE TRANSPARENCY IN REMOTE DEVICE OPERATION

(71) Applicants: Oded NOAM, Tel Aviv (IL); ORBS LTD., Tel Aviv (IL)

(72) Inventor: ODED NOAM, Tel Aviv (IL)

(21) Appl. No.: 18/270,580

(22) PCT Filed: Dec. 31, 2021
(86) PCT No.: PCT/US2021/065857

§ 371 Date: Jun. 30, 2023

Related U.S. Application Data
(60) Provisional application No. 63/133,227, filed on Dec. 31, 2020.

(51) Int. Cl. H04L 9/08; H04L 9/00

(52) U.S. Cl. CPC H04L 9/0825; H04L 9/0861; H04L 9/50

(57) ABSTRACT

Systems and methods are disclosed for using decentralized networks to ensure transparency in remote device operation. In one implementation, outputs are received from a sensor and encrypted using a public cryptographic key. The encrypted outputs are transmitted to nodes within a decentralized network. At least one of the nodes within the decentralized network receives the encrypted outputs and decrypts the received encrypted outputs using a share of a network key.

### PRIORITY CLAIM

This application is related to and claims the benefit of priority to U.S. Patent Application No. 63/133,227, filed Dec. 31, 2020, which is incorporated herein by reference in its entirety.

### TECHNICAL FIELD

Aspects and implementations of the present disclosure relate to data processing and, more specifically, but without limitation, to using decentralized networks to ensure transparency in remote device operation.

### BACKGROUND

Data/records can be stored on a decentralized or distributed ledger such as blockchain that is synchronized across multiple computing/storage devices. Various cryptographic techniques can be utilized to secure such records.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates example scenario(s) described herein, according to example embodiments.

FIG. 3 illustrates example scenario(s) described herein, according to example embodiments.

FIG. 4 is a flow chart illustrating aspects of a method for using decentralized networks to ensure transparency in remote device operation, in accordance with an example embodiment.

FIG. 5 is a flow chart illustrating aspects of a method for using decentralized networks to ensure transparency in remote device operation, in accordance with an example embodiment.

FIG. 6 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to using decentralized networks to ensure transparency in remote device operation.

An example environment is depicted and described herein. In certain implementations, the described technologies can be implemented in conjunction with various nodes, devices, and/or users. For example, an example system can include a decentralized or distributed leger such as a blockchain that can be distributed and/or stored across multiple connected nodes. Examples of such nodes are depicted and described herein. As also described herein, consensus algorithm(s) can be applied in relation to the referenced nodes. Such nodes may be employed in a permissioned or permissionless environment (e.g., using algorithms such as proof-of-stake or delegated proof-of-stake to map the nodes that participate in the protocol).

The referenced nodes can be computing devices, storage devices, and/or any other such connected device or component configured to generate and/or provide verification (e.g., for a transaction, operation, etc.). Various nodes can be connected to one another (directly or indirectly) via various network connections, thereby forming a distributed computing environment or network.

In an example transaction, ownership of a digital token can be transferred from one address to another. To authenticate the transaction, the transaction recording the transfer can be signed by the originating party using a private key associated with that originating party (e.g., as stored on a device). Such a private key can be a cryptographic key (e.g., a string of bits used by a cryptographic algorithm to transform plain text into cipher text or vice versa) that may be kept secret by a party and used to sign transactions (e.g., the transfer of a token to another user, server, etc.) such that they may be verified using the described distributed computing environment.

The referenced signed transaction can then be broadcast across the distributed computing environment/network, where it can be verified, e.g., using the public key associated with the originating party. Such a “public key” can be a cryptographic key that is distributed to, or available to the referenced node(s) so that signed transactions associated with the public key may be verified by the nodes.

During the referenced verification process, the transaction can be accessed or selected by a consensus node (e.g., a device or ‘miner’ configured to verify transactions and add new blocks to a blockchain), verified using the public key, timestamped, and added to a “block” that includes other transaction(s).

Adding completed blocks to the blockchain ledger forms a permanent public record of various included transactions. The blockchain ledger can be replicated and distributed across multiple nodes within the distributed environment. In the event that a user tries to utilize a previously transferred digital token, the first transaction conducted using the token address may promulgate to remote nodes faster than any subsequently conducted transaction using the same token address. This allows more time for additional blocks to be added to the blockchain that include the first transaction. In this scenario, a node that receives two separate chains that include blocks with transactions originating from the same token address will choose the longest chain, which should be associated with the first conducted transaction. In such a manner, the blockchain may be used to provide verification of various operations, transactions, etc.

As described herein, the disclosed technologies implement asymmetric threshold encryption to ensure the security and veracity of outputs originating from external or remote devices. In other implementations, the described technologies can be utilized to provide transparent read receipts, such that, for example, one party cannot access the contents of a message they received without publicly acknowledging having received and/or read the message.

In certain implementations, the described technologies can be implemented in conjunction with a decentralized network of independent parties. The assumption may be that honesty is common enough to ensure that in such decentralized network, it is unlikely for anyone to be able to form a coalition of dishonest participants. Using threshold encryption, the described technologies ensure encrypted messages cannot be read without at least a few honest participants knowing about it.

It should also be understood that the described technologies can be implemented in numerous scenarios in which verifying or ensuring the veracity of data may be advantageous. For example, the described technologies can be implemented with respect to temperature sensor(s) deployed with respect to a shipping container. The sensor may be used to determine proper handling of transported goods and/or to determine liability in case the container was mishandling. A carrier in possession of the container may try to verify that the temperature reading is valid before handing over the container and damage the sensor in case they want to conceal its reading.

In another example scenario, the described technologies can be implemented with respect to an air quality sensor can be used in a factory to alert when there are changes in the factory's pollutant outputs, and also to log the pollutant levels for compliance record-keeping. In the event of an external audit, the factory may wish to omit, conceal, etc. such alert logs. Using the described technologies, such manipulation can be prevented.

In another example scenario, the described technologies can be implemented with respect to a ‘black box’ for a vehicle (e.g., car, truck, or bus). The driver may wish to hide evidence of his reckless driving prior to an investigation or an external audit. Using the described technologies, such data can be preserved.

In another example scenario, the described technologies can be implemented with respect to an access control system that provides access control to a computer terminal Infiltrators may gain access to the computer system, access it and remove traces of the access logs after the fact. Using the described technologies, such manipulations can be prevented.

Moreover, as noted, the described technologies can be utilized with respect to read receipts. For example, user ‘Alice’ sends an encrypted message to ‘Bob,’ but wants to avoid a situation in which Bob can deny having read the contents of the message. Using the described technologies, such occurrences can be publicly verified, as described herein.

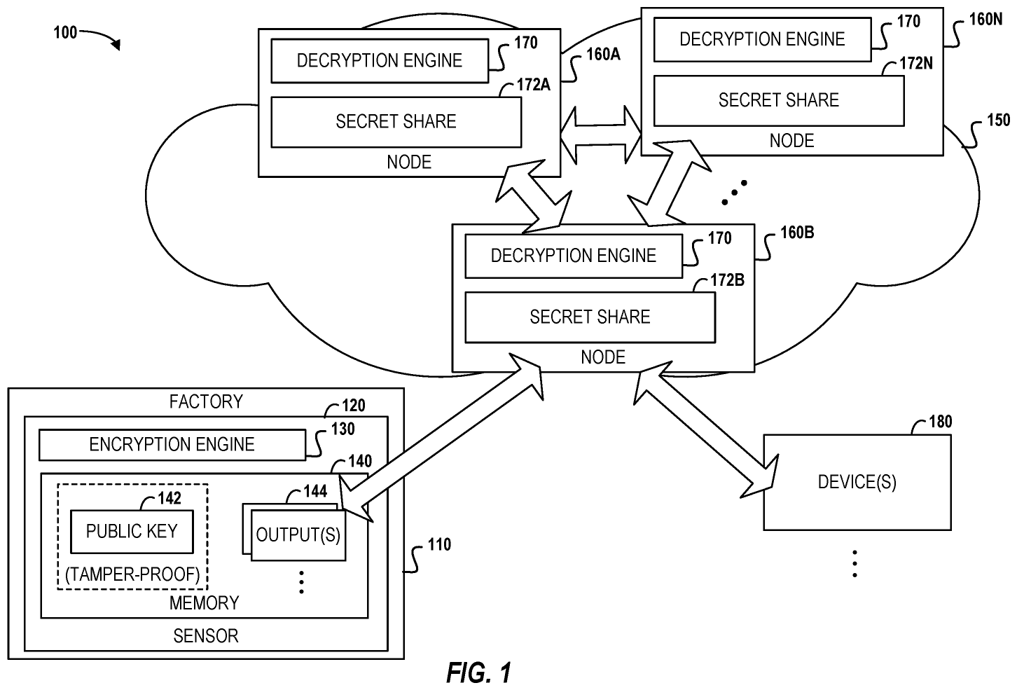

FIG. 1 illustrates an example system 100, in accordance with some implementations. As shown, the system 100 includes components such as factory 110. Factory 110 can be a manufacturing plant or other such operation, aspects of which are controlled or automated via devices including a laptop computer, a desktop computer, a terminal, a mobile phone, a tablet computer, a smart watch, a wearable device, a connected device, a speaker device, a server, a programmable controller, and the like. As noted, the referenced ‘factory’ is provided for purposes of example, and the described technologies can be similarly implemented in any number of other settings, contexts, etc.

Certain devices or components within the referenced factory can include sensor(s) 120. Such sensor(s) can be, for example, sensor(s) that monitor various phenomena, such as the amount of pollution being emitted, temperature, humidity, etc. Doing so many be necessary for regulatory compliance, e.g., to confirm that the operation of the factory complies with emission guidelines, to document that the factory is operating under safe conditions, etc.

In one example scenario, factory 110 can include a furnace and corresponding regulatory guidelines may permit such a furnace to emit a defined amount of pollutants to the atmosphere (e.g., within a defined time interval, such as per day, week, month, etc.). In such a scenario, sensor 120 can be configured to, for example, monitor the amount of pollutants emitted by the factory. Data/output(s) 144 from the sensor can reflect such emissions (based upon which aspects of the operation of the factory can be adjusted, stopped, etc., e.g., if emission levels approach or exceed prescribed limits). In certain implementations, the described technologies can also be configured to generate or provide alerts, notifications, etc., to regulatory authorities (e.g., regarding incidents of the factory exceeding regulatory guidelines).

It can be appreciated that under various circumstances the veracity of the data, outputs, etc. originating from the factory may be suspect, as the factory may be incentivized to manipulate the data it provides (e.g., to avoid fines, scrutiny, etc.). Additionally, in certain scenarios it may be valuable to independently verify the accuracy of such data, outputs, etc.

Accordingly, in certain implementations the described technologies can be implemented. Doing so can be advantageous for various reasons, including to verify and/or ensure the veracity of the output(s), data, etc., originating from the factory. For example, in one scenario regulatory authorities can provide, configure, etc., sensor(s) 120 for installation at the factory. Such a sensor 120 can generate output(s) 144 (reflecting, for example, emissions of the factory), and such outputs can be encrypted by encryption engine 130.

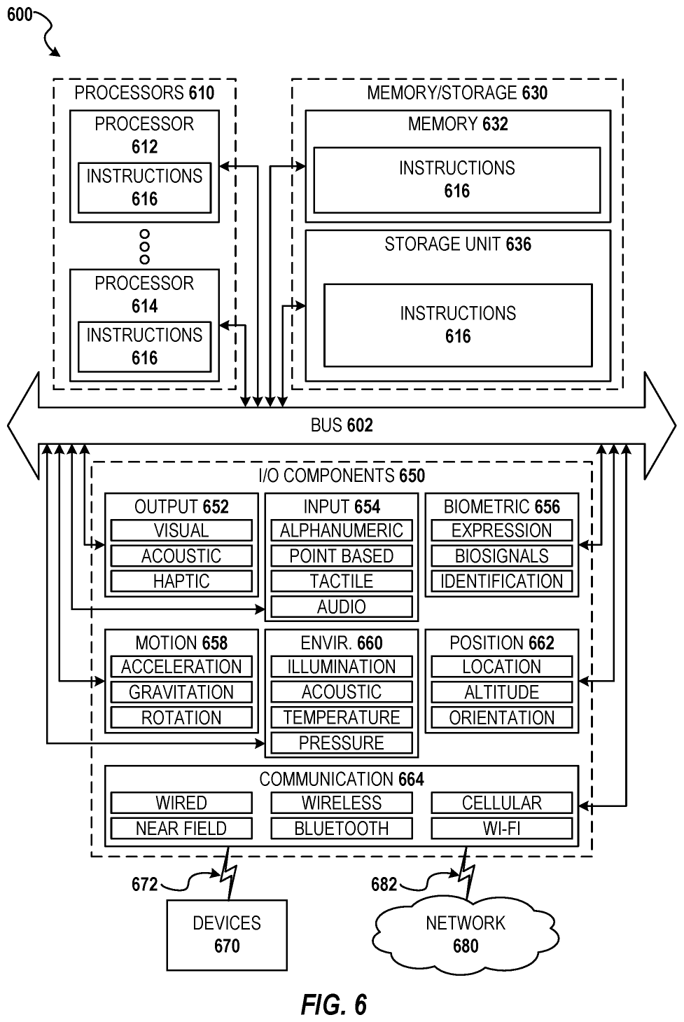

Encryption engine 130 can be an application can be a program, module, or other executable instructions that configure/enable the device/system to perform various cryptographic operations such as are as described in detail herein. Such application(s) can be stored in memory of device 110 (e.g., memory 630 as depicted in FIG. 6 and described below). One or more processor(s) of device 110 (e.g., processors 610 as depicted in FIG. 6 and described below) can execute such application(s). In doing so, device 110 can be configured to perform various operations, as described herein.

In one example scenario, n independent parties can establish a decentralized network (e.g., nodes 160 that make up network 150 as shown in FIG. 1). Using a defined protocol the referenced nodes can establish or generate a k-of-n threshold encryption key (e.g. public key 142 as shown in FIG. 1). Such a public key can be expressed as PKₙₑₜ, with n shares of the secret key SK₁ . . . SKₙ each kept by their holder securely (e.g. secret shares 172A, 172N, etc., as shown in FIG. 1).

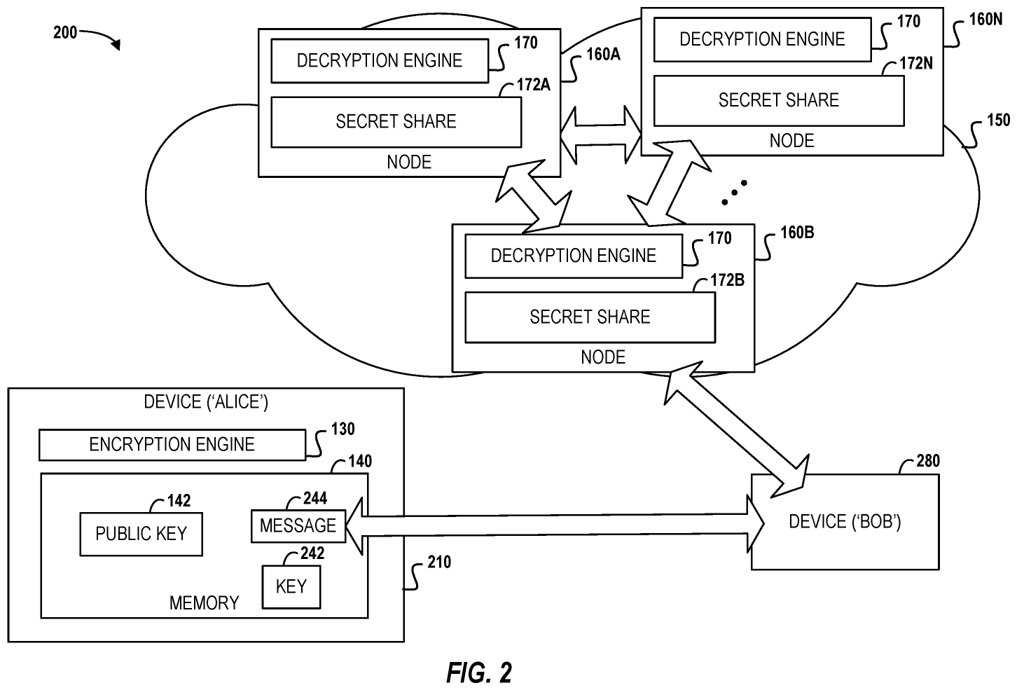

Using threshold encryption techniques, a device or entity possessing PKₙₑₜ can encrypt a message, data, output, etc., which can then only be decrypted by any k key shares. Moreover, using compatible threshold signature scheme(s), any k key shares can sign a message, which can then be verified by anyone as being signed by the decentralized network. In certain implementations, the referenced public key (PKₙₑₜ) can be published and/or stored in a tamper-proof or secure portion of memory 140 of sensor 120 (e.g., as shown in FIG. 1). In other implementations, the public key can be stored in any section of memory 140 (e.g., non-secure memory) (e.g., as shown in FIG. 2).

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

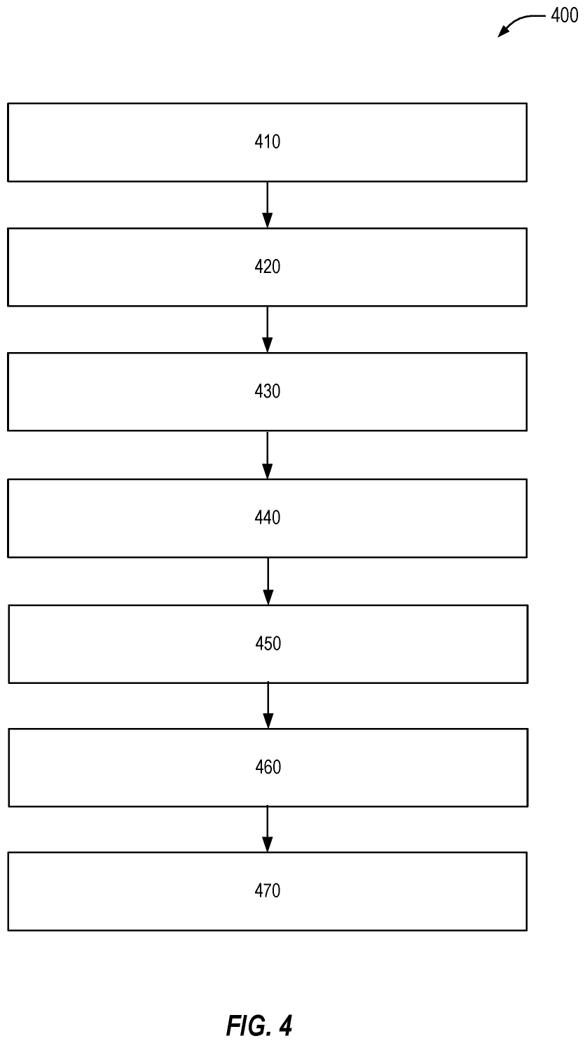

In certain implementations, various aspects of the described technologies can be implemented as method(s) performed by processing logic that can comprise hardware (circuitry, dedicated logic, etc.), software (such as is run on a computing device such as those described herein), or a combination of both. For example, FIG. 4 is a flow chart illustrating a method 400, according to an example embodiment, for using decentralized networks to ensure transparency in remote device operation. The method is performed by processing logic that can comprise hardware (circuitry, dedicated logic, etc.), software (such as is run on a computing device such as those described herein), or a combination of both. In one implementation, the method 400 is performed by one or more elements depicted and/or described in relation to FIG. 1 (including but not limited to engine 130, one or more applications or modules executing thereon), while in some other implementations, the one or more blocks of FIG. 4 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 410, one or more outputs can be received, e.g., from one or more sensors, such as described herein. In certain implementations, the referenced output(s) 144 can be encrypted with public key 142, e.g., by encryption engine 130 (operation 420). Such a public key can, for example, correspond to a threshold-encryption quorum in a decentralized network 150, as described in further detail herein.

At operation 430, Such encrypted output(s) (e.g., an encrypted copy of the ‘raw’ data originating from sensor 120, reflecting the emissions of the factory) can be transmitted to (and/or be received by, e.g., at operation 440) one or more node(s) 160 within the decentralized network 150. Such encrypted data can be shared among the various nodes(s) 160A-160N.

As shown in FIG. 1, each node 160 can maintain its own respective secret share 172. Using such a secret share, each node can generate a portion of the decrypted output originating from the sensor 120 (e.g., at operation 450, wherein the encrypted outputs can be decrypted by various nodes, as described herein). In a scenario in which a threshold number of nodes have decrypted respective shares of such an output, the nodes can collectively decrypt the output (using threshold cryptographic techniques). For example, each member i of the network can apply her share of the secret key SKᵢ on the cipher, such that when more than k different results can be published on a shared ledger (e.g., at operation 460, wherein results of the referenced decryption are published) such that anyone with access to it can read the output. In doing so, various operations can be initiated (operation 470), such as are described herein. For example, deviations, manipulations, etc., originating from the factory can be publicly identified and/or revealed (e.g., to enable third parties 180 to independently review and verify the outputs). Additionally, in certain implementations such decryption techniques can be provided back to the factory, such that the factory can be incentivized to ensure proper ongoing operation of the sensor (or otherwise risk the ability to monitor its own output).

Each of the referenced nodes 160 can be, for example, a server computer, computing device, storage service (e.g., a ‘cloud’ service), etc. and can include decryption engine 170. Decryption engine 170 can be an application that configures/enables the node to perform various decryption operations, e.g., as described in detail herein.

In certain implementations, the operator of a node can be responsible for securing the local secret shares 172 (e.g., by maintaining an encrypted copy of it on unprotected hardware and/or performing the cryptographic operations on it on a hardware security module that decrypts the share and performs the required operation in a secure environment). It should be understood, however, that even in a scenario in which the security of multiple nodes were compromised, the underlying secrets are still secured as long as a sufficient minority of the nodes remain secured (i.e., the compromised nodes together do not exceed the required encryption threshold t).

In an alternative implementation, public key 142 (PKₙₑₜ) can be securely stored (e.g., in the device/sensor's tamper-proof memory). Outputs 144 can be securely encrypted using PKₙₑₜ and written in their encrypted form. When a party (e.g., third party 180) wishes to read, access, review etc. such outputs, such a party can create a temporary encryption key-pair (PK_{reader}, SK_{reader}). The output(s) (in their encrypted form) and PK_{reader} can be transmitted to multiple nodes/members 160 of the n parties participating in the network 150. Every member/node i applies her respective share 172 of the secret key SKᵢ on the cipher. Every member i encrypts the output they received with the key PK_{reader} and publishes the results in a shared ledger. Accordingly, when more than k different results are written on the ledger, the owner of SK_{reader} can read the device's output.

FIG. 2 illustrates an example system 200, in accordance with some implementations.

It should be understood that certain aspects of the depicted implementation may utilize commutative encryptions, in which dec_{A}(dec_{B}(enc_{A}(enc_{B}(x))))=x where B is the cryptosystem used for the network threshold encryption and A may be any encryption system.

As shown in FIG. 2, in another example scenario, the public key 142 (e.g., represented as PKₙₑₜ) is stored in the tamper-proof memory 140 of device 210 (which can be, for example, Alice's device). Outputs of the device (e.g., message 244 from Alice to Bob) can be doubly-encrypted (by applying both encryptions, one after the other), e.g., using both PK_{reader} and PKₙₑₜ, and written in their encrypted form. The party that wishes to read a device output (e.g., Alice) encrypts the ciphertext output with their private encryption key and sends the output to as many members of the n parties/nodes 160 participating in the decentralized network 150. Every member i applies her share of the secret key SK on the cipher and publishes the results in a shared ledger. When more than k different results are written on the ledger, the reader can read the device's output with their private decryption key.

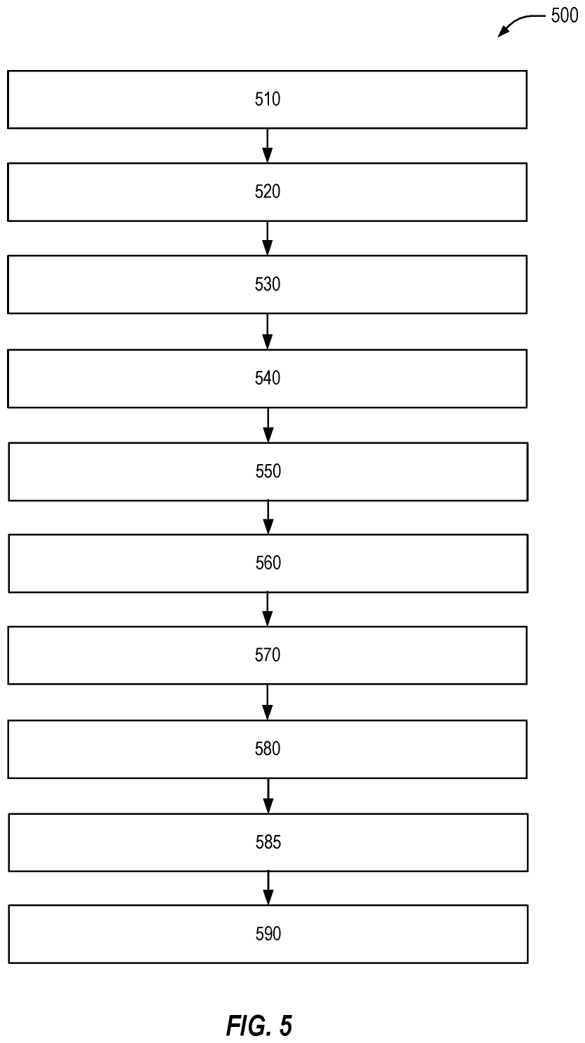

FIG. 5 is a flow chart illustrating a method 500, according to an example embodiment, for using decentralized networks to ensure transparency in remote device operation. The method is performed by processing logic that can comprise hardware (circuitry, dedicated logic, etc.), software (such as is run on a computing device such as those described herein), or a combination of both. In one implementation, the method 500 is performed by one or more elements depicted and/or described in relation to FIG. 2 (including but not limited to engine 130, one or more applications or modules executing thereon), while in some other implementations, the one or more blocks of FIG. 5 can be performed by another machine or machines.

In certain implementations, the described technologies can be implemented with respect to read receipts for messaging. For example, a sender of an electronic message sender may not be assured of receiving a notification in the event of receipt of the message by the recipient, failure of receipt of the message, etc.

For example, user ‘Alice’ (corresponding to device 210) may wish to send a message m to user ‘Bob’ (corresponding to device 280) and be further notified if Bob read her message. Alice generates a random one-time key K (242) (operation 510, wherein device 210 generates a key, such as a random one time key). She encrypts the message 244 with the key K (E_{K}(m) can represent the encrypted message) (operation 520, wherein a message is encrypted with the generated key) and encrypts the key K itself with the public key PK (142) (operation 530, wherein the generated key is encrypted with the public key) (generating E_{PK}(K)). Alice sends E_{K}(m) and E_{PK}(K) to Bob (280) (operating 540, wherein the encrypted message and the encrypted generated key are transmitted to a user and/or one or more nodes within a decentralized network).

Bob receives the message but cannot read in because it is encrypted (operation 550). He sends E_{PK}(K) to members/nodes 160 of the decentralized network 150 (operation 560). Each member that receives Bob's request (operation 570) partially-decrypts it with their share 172 of the network key (operation 580) and publishes the result on the shared ledger (operation 585). As soon as enough members publish their share of the decryption, various operations can be performed (operation 590). For example, Bob can decrypt K and use it to privately decrypt the message m. Alice can observe the shared ledger (within network 150) and see that Bob has requested (and was granted) access to the decryption key, thus functioning as proof of delivery.

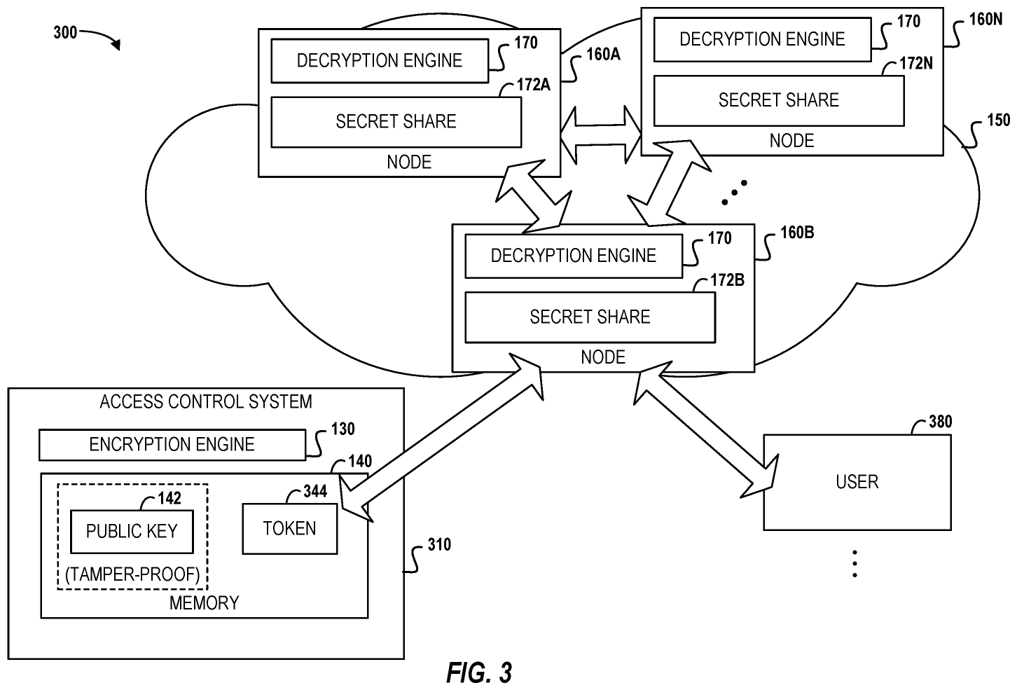

FIG. 3 illustrates an example system 300, in accordance with some implementations, such as are described and depicted herein.

It can be appreciated that, in certain implementations, a secure computer system can be used to store secret information. When a user wishes to access the system, she needs to authenticate with an access control system, which issues her with an access token verifiable by the secure system. In certain implementations, the security protocol of such a system can include generation and logging of access tokens, allowing audit and investigation of possible data exposure events.

However, it can be appreciated that allowing certain users (e.g., administrators) to access to the secure system poses a special risk, as the administrator may access—in addition to the secret data—the security logs themselves. Doing so can, for example, enable the manipulation of such logs. This risk remains when access logs are stored on a remote system, to the extent that the same personnel have administrator privileges on the remote system.

To reduce such risk, the described technologies can be configured to store such access logs on a ledger shared by multiple entities/nodes within a decentralized network, in accordance with the disclosed systems, methods, and other technologies. An infiltrator wishing to successfully manipulate such data will need administrator access for all the systems participating in the decentralized network (which may include different systems maintained by different organizations in different locations).

To ensure access logs are stored on the decentralized network, the secure system can be configured to only allow access via security tokens that are digitally signed by the public key (PK) of the decentralized system. For example, the user 380 authenticates with the access control system 310, which issues her a security token. In another example implementations, public key PKₙₑₜ is stored in the tamper proof memory of the access device. When a subject requests access from the access device, she is provided with a temporary challenge (e.g., an arbitrary data sequence). Such a subject can authenticate (via various techniques), e.g., with at least k members of the decentralized network, and sends them the challenge it received.

The system sends the security token to the members of the decentralized network to be signed. Using the described technologies, each member/node 150 applies her respective share 172 of the secret key SKᵢ and writes the resulting signature share on the shared ledger. When a sufficient number of members have contributed their signature shares, the access control system can combine the shares to create a valid signature of the security token. This signature is a valid digital signature associated with the public key PK. When more than k different results are written on the ledger, the subject can compose a valid digital signature of the challenge, the signature is associated with the public key PK. The access control system 310 sends the signed access token to the user, which is then able to access the secure system.

It can therefore be appreciated that the described technologies are directed to and address specific technical challenges and longstanding deficiencies in multiple technical areas, including but not limited to cryptography, cybersecurity, and distributed and decentralized systems. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

It should also be noted that while the technologies described herein are illustrated primarily with respect to using decentralized networks to ensure transparency in remote device operation, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 6 is a block diagram illustrating components of a machine 600, according to some example implementations, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein can be executed. The instructions 616 transform the general, non-programmed machine into a particular machine programmed to carry out the described and illustrated functions in the manner described. In alternative implementations, the machine 600 operates as a standalone device or can be coupled (e.g., networked) to other machines. In a networked deployment, the machine 600 can operate in the capacity of a server machine or a client machine in a server-client network environment, or as a peer machine in a peer-to-peer (or distributed) network environment. The machine 600 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, an industrial controller, a microcontroller, a single-board computer, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 can include processors 610, memory/storage 630, and I/O components 650, which can be configured to communicate with each other such as via a bus 602. In an example implementation, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), a Cryptographic Secure Element (SE), a Hardware Security Module, a Trusted Execution Environment (TEE) within a processor, another processor, or any suitable combination thereof) can include, for example, a processor 612 and a processor 614 that can execute the instructions 616. The term “processor” is intended to include multi-core processors that can comprise two or more independent processors (sometimes referred to as “cores”) that can execute instructions contemporaneously. Although FIG. 6 shows multiple processors 610, the machine 600 can include a single processor with a single core, a single processor with multiple cores (e.g., a multi-core processor), multiple processors with a single core, multiple processors with multiples cores, or any combination thereof.

The memory/storage 630 can include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 can also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of the processors 610 are examples of machine-readable media.

As used herein, “machine-readable medium” means a device able to store instructions (e.g., instructions 616) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine (e.g., processors 610), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 650 can include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 can include many other components that are not shown in FIG. 6. The I/O components 650 are grouped according to functionality merely for simplifying the following discussion and the grouping is in no way limiting. In various example implementations, the I/O components 650 can include output components 652 and input components 654. The output components 652 can include visual components (e.g., a display such as a plasma display panel (PDP), a light emitting diode (LED) display, a liquid crystal display (LCD), digital ink display, a projector, or a cathode ray tube (CRT)), acoustic components (e.g., speakers), haptic components (e.g., a vibratory motor, resistance mechanisms), other signal generators, and so forth. The input components 654 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 650 can include biometric components 656, motion components 658, environmental components 660, or position components 662, among a wide array of other components. For example, the biometric components 656 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 can include acceleration sensor components (e.g., accelerometer), gravitation sensor components, rotation sensor components (e.g., gyroscope), and so forth. The environmental components 660 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 662 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 650 can include communication components 664 operable to couple the machine 600 to a network 680 or devices 670 via a coupling 682 and a coupling 672, respectively. For example, the communication components 664 can include a network interface component or other suitable device to interface with the network 680. In further examples, the communication components 664 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 can be another machine or any of a wide variety of peripheral devices (e.g., a peripheral device coupled via a USB).

Moreover, the communication components 664 can detect identifiers or include components operable to detect identifiers. For example, the communication components 664 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 664, such as location via Internet Protocol (IP) geolocation, location via Wi-Fi® signal triangulation, location via detecting an NFC beacon signal that can indicate a particular location, and so forth.

In various example implementations, one or more portions of the network 680 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 can include a wireless or cellular network and the coupling 682 can be a Code Division Multiple Access (CDMA) connection, a Global System for Mobile communications (GSM) connection, or another type of cellular or wireless coupling. In this example, the coupling 682 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 6G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 can be transmitted or received over the network 680 using a transmission medium via a network interface device (e.g., a network interface component included in the communication components 664) and utilizing any one of a number of well-known transfer protocols (e.g., HTTP). Similarly, the instructions 616 can be transmitted or received using a transmission medium via the coupling 672 (e.g., a peer-to-peer coupling) to the devices 670. The term “transmission medium” shall be taken to include any intangible medium that is capable of storing, encoding, or carrying the instructions 616 for execution by the machine 600, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
receiving one or more outputs from a sensor;
encrypting the received one or more outputs using a public cryptographic key;
transmitting the encrypted outputs to one or more nodes within a decentralized network;
wherein at least one of the one or more nodes within the decentralized network: receives the encrypted outputs and decrypts the received encrypted outputs using a share of a network key.

2. The system of claim 1, wherein the at least one or more nodes within the decentralized network publishes a result of a decryption of the received encrypted outputs to a shared ledger.

3. The system of claim 3, further comprising initiating one or more operations based on one or more results of the decryption of the received encrypted outputs.

4. The system of claim 1, wherein the public key is stored on a secure memory device.

5. The system of claim 1, wherein the public key corresponds to a threshold-encryption quorum within the decentralized network.

6. The system of claim 1, wherein decrypting the received encrypted outputs comprises generating a portion of a decrypted output.

7. The system of claim 1, wherein decrypting the received encrypted outputs comprises decrypting the received encrypted outputs using portions of the decrypted output originating from one or more nodes.

8. The system of claim 1, wherein decrypting the received encrypted outputs comprises decrypting the received encrypted outputs using a portions of the decrypted output originating from one or more nodes that meet an threshold-encryption quorum within the decentralized network.

9. A method comprising:
generating a cryptographic key at a first device;
encrypting a message with the generated cryptographic key;
encrypting the generated cryptographic key with a public key; and
transmitting the encrypted message and the encrypted generated cryptographic key to one or more nodes within a decentralized network;
wherein the transmitted encrypted message and the encrypted generated cryptographic key are received by a second device, and wherein the second device transmits the received encrypted generated cryptographic key to at least one or more nodes within the decentralized network.

10. The method of claim 9, wherein at least one or more nodes within the decentralized network receives the received encrypted generated cryptographic key.

11. The method of claim 10, wherein the at least one or more nodes within the decentralized network decrypts the received encrypted generated cryptographic key.

12. The method of claim 11, wherein the at least one or more nodes within the decentralized network decrypts the received encrypted generated cryptographic key with a share of a network key.

13. The method of claim 12, wherein the at least one or more nodes within the decentralized network publishes the result of the decryption of the received encrypted generated cryptographic key to a shared ledger.

14. The method of claim 13, further comprising initiating one or more operations based on one or more results of the decryption of the received encrypted generated cryptographic key.

15. The method of claim 14, wherein the one or more operations comprises decrypting the encrypted message at the second device using the decrypted encrypted generated cryptographic key.

16. The method of claim 14, wherein the one or more operations comprises verifying receipt of the encrypted message at the second device.

17. A non-transitory computer readable medium having instructions stored thereon that, when executed by a processing device, cause the processing device to perform operations comprising:
generating a cryptographic key at a first device;
encrypting a message with the generated cryptographic key;
encrypting the generated cryptographic key with a public key; and
transmitting the encrypted message and the encrypted generated cryptographic key to one or more nodes within a decentralized network;
wherein the transmitted encrypted message and the encrypted generated cryptographic key are received by a second device, wherein the second device transmits the received encrypted generated cryptographic key to at least one or more nodes within the decentralized network, and wherein the at least one or more nodes within the decentralized network decrypt the received encrypted generated cryptographic key with a share of a network key and publish the result of the decryption of the received encrypted generated cryptographic key to a shared ledger.

18. The non-transitory computer readable medium of claim 17, wherein at least one or more nodes within the decentralized network receives the received encrypted generated cryptographic key.

19. The non-transitory computer readable medium of claim 18, wherein the at least one or more nodes within the decentralized network decrypts the received encrypted generated cryptographic key.

20. The non-transitory computer readable medium of claim 17, further comprising initiating one or more operations based on one or more results of the decryption of the received encrypted generated cryptographic key.

21. The non-transitory computer readable medium of claim 20, wherein the one or more operations comprises decrypting the encrypted message at the second device using the decrypted encrypted generated cryptographic key.

22. The non-transitory computer readable medium of claim 20, wherein the one or more operations comprises verifying receipt of the encrypted message at the second device.
